(19) United States
(12) Patent Application Publication
(10) Pub. No.: US 2009/0188938 A1
(43) Pub. Date: Jul. 30, 2009

(54) Apparatus for dispensing flavors in specified quantities

(76) Inventors: Jeffrey Blaine Farris, Southlake, TX (US); Thomas J. Chadwell, San Antonio, TX (US); Phillip B. Frazier, Helotes, TX (US)

Correspondence Address: Mr. Christopher John Rourk;Jackson Walker LLP, 901 Main Street, Suite 6000, DALLAS, TX, 75202, US

(21) Appl. No.: 12/011,172

(22) Filed: Jan. 24, 2008

(51) Int. Cl. B67D 5/52; B67D 5/06; B65D 83/00; B67D 5/00

(52) U.S. Cl. 222/1; 222/135; 222/144.5

(57) ABSTRACT

An apparatus for dispensing flavors to beverages or food products is provided. A programmable pump apparatus allows for dispensing a varying amount of a selected flavor in response to user input. A main tower is mountable on countertops or other work surfaces such as a home, office, or food preparation area, and allows users to select one or more flavors and control the amount of flavor dispensed. The apparatus may comprise buttons that can be programmed for pour and hold with a specified time-out and a guard time delay to prevent accidental dispensing of flavor.

### FIELD OF THE INVENTION

The invention relates to an apparatus for dispensing flavoring compounds, such as syrups, into a beverage or food product, and comprises a programmable pump apparatus for dispensing a varying amount of a selected flavor in response to user input.

### BACKGROUND OF THE INVENTION

Methods for adding flavor to beverages and food products are known in industry. Such methods allow an individual to customize a beverage or food product which has been prepared separately for a larger group of people. Examples of this practice are found particularly in the beverage industry, where soft drinks may be prepared by adding a flavor at a continuous rate to a stream of carbonated water, or by using a manual hand pump.

### SUMMARY OF THE INVENTION

The current invention comprises an apparatus which allows a user to dispense flavoring compounds, such as syrups, into a beverage or food product, and comprises a programmable apparatus for dispensing a varying amount of a selected flavor in response to user input.

In accordance with an exemplary embodiment of the present invention, an apparatus is provided for dispensing flavors, such as to beverages or food products. The apparatus may comprise a housing, a pump assembly, a nozzle for dispensing flavor, and a control board including a user interface which is capable of activating the pump assembly.

In another exemplary embodiment, the housing comprises a main tower, which can be constructed of wood, plastic, metal, or other suitable solid or composite materials. The housing can be capable of being mounted on a countertops or other work surfaces in a home, office, food preparation area or other suitable locations.

In another exemplary embodiment, the pump assembly can include one or more pumps, each connected to a source of flavor. The pumps are further connected to a solenoid, which controls the flow of the flavoring material to a nozzle for dispensing flavor. Each solenoid is capable of being activated by a control board, which is connected to a user interface. In one embodiment, each solenoid is capable of being activated for a predetermined period of time, such as between 0.25 and 2.00 seconds. When several solenoids are included in a solenoid assembly, the control board can activate one or more of the solenoids.

In another exemplary embodiment, the pump assembly can receive a source of pressured liquid or gas, such as carbon dioxide gas (CO₂). The source of pressurized liquid or gas can be in fluid communication with one or more of the pumps, and can supply pressure to assist in the movement of the flavor through the pump and through the nozzle, such as where the pump is hydraulically powered and maintains a supply line at a predetermined pressure.

The above embodiments can also include buttons in the user interface that are capable of interacting with the control board. The control board can be programmed for pour and hold with a specified time-out and a guard time delay to prevent accidental dispensing of flavor.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system showing an exploded view of a flavor dispenser in accordance with an exemplary embodiment of the current invention;

FIG. 2 is a diagram of an exemplary embodiment of the main tower;

FIG. 3 is a diagram of a system for dispensing flavoring compounds in accordance with an exemplary embodiment of the current invention;

FIG. 4 is a diagram of a template for a flavor dispenser in an exemplary embodiment of the present invention;

FIG. 5 is a diagram of a template for a flavor dispenser in an exemplary embodiment of the current invention;

FIG. 6 show three exemplary locations for the electrical panel in exemplary embodiments of the invention;

FIG. 7 is a diagram of a system for controlling a flavor dispenser in accordance with an exemplary embodiment of the present invention; and

FIG. 8 is a flow chart of a method for programming and controlling a flavoring compound dispenser in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

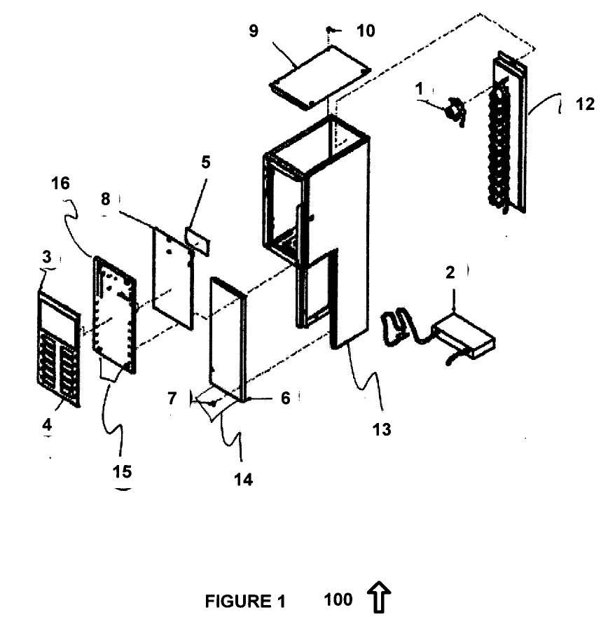

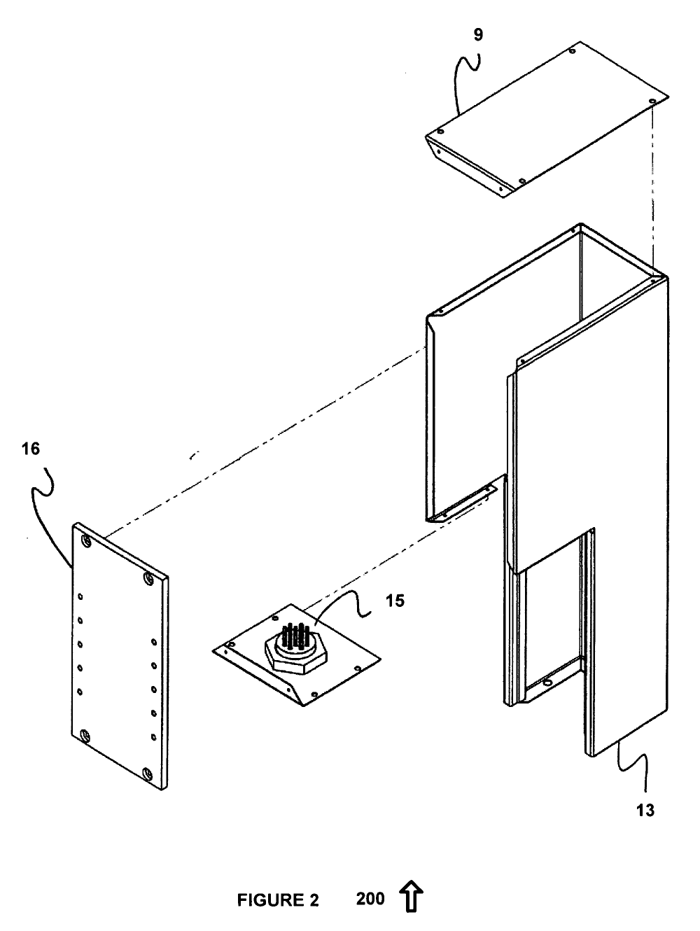

FIG. 1 is a diagram of a system 100 showing an exploded view of a flavor dispenser in accordance with an exemplary embodiment of the current invention. The flavor dispenser includes a main tower (13, FIG. 2). In this exemplary embodiment, the main tower (13) can be constructed of metal, plastic, wood, a composite material or other suitable materials. The main tower (13) includes a top panel (9) attached via a screw (10) to the top of the main tower (13), a valve assembly (12) having a plurality of solenoid valves (1) or other suitable valves attached to the back of the main tower (13), and a power supply (2) connected to the main tower (13). In this exemplary embodiment, the main tower (13) includes a splash panel (6) removably attached to the front of the main tower (13), such as by a screw (7). A hinged frame can also be attached to the front portion of the main tower (13).

In this exemplary embodiment, the dispenser can include a non-conductive faceplate (16), which can be attached to the front of the main tower (13), such as by the hinged frame. The dispenser (FIG. 1) further includes a printed circuit control board (8), which can be attached to the rear of the non-conductive faceplate (16). The dispenser (FIG. 1) can include an overlay (3) having a plurality of flavor identifiers (4), which is attached to the front of the non-conductive faceplate (16) to identify electrically coupled switch locations on control board (8). The dispenser also includes a drip tray (14), and a nozzle (15).

FIG. 2 is a diagram 200 of an exemplary embodiment of the main tower (13). The main tower (13) includes a non-conductive faceplate (16) which can be removably attached to the front portion of the main tower (13). The main tower (13) also includes a top panel (9), which is removably attached to the top of the main tower (13). An assembly housing a plurality of nozzles (15) or a plate fitted with a plurality of nozzles is used to direct fluids such as a flavoring compound out of the main tower into an awaiting cup, vessel or other container, without the need to combine the flavoring compound with another fluid such as carbonated water, and without the need to provide the additional systems for delivering such other fluids in combination with the flavoring compound.

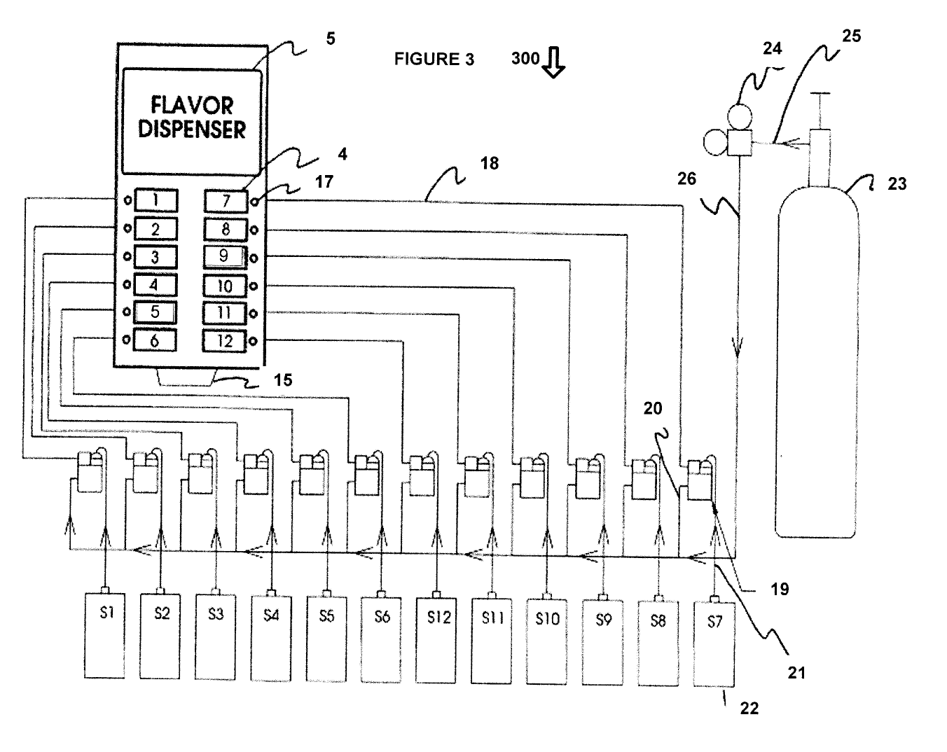

FIG. 3 is a diagram of a system 300 for dispensing flavoring compounds in accordance with an exemplary embodiment of the current invention. The flavor dispenser (FIG. 1) includes a system for delivering a flavor compound such as syrup to a nozzle selected by a user. The flavor dispenser includes a source of pressure to move syrup through a series of tubes, such as a carbon dioxide (CO₂) cylinder (23). The CO₂ cylinder (23) is in fluid communication with a pressure regulator (24), such as via a segment of CO₂-to-regulator tubing (25), which may be ¼ tubing. In one exemplary embodiment, the pressure regulator can be a 10-15 PSIG regulator. The pressure regulator (24) is in fluid communication with, and capable of regulating the pressure in, a segment of regulator-to-pump tubing (26). The regulator-to-pump tubing (26) branches off and is in fluid contact with one or more pneumatically-powered syrup pumps (19) or other suitable pumps, such as twelve syrup pumps. Each syrup pump (19) is also in fluid contact with one or more bag in box (BIB) syrup containers (22) or other suitable containers, such that syrup from the BIB syrup container (22) can be drawn into the syrup pump (19). Each syrup pump (19) is also in fluid communication with a segment of pump-to-dispenser tubing (18), such as ¼ tubing, such that syrup can be propelled through the pump-to-dispenser tubing (18) under power of the pressure provided by the CO₂ cylinder (23). The pump-to-dispenser tubing (18) is in fluid communication with a plurality of solenoids (not shown), which are each in fluid communication with a plurality of nozzles (15), which allows syrup to be dispensed into an awaiting cup or other container. The specific syrup to be dispensed, and the duration that the syrup is dispensed is controlled by the control board (8) and displayed on an LCD module (5), which can be configured to receive user input via front panel flavor identifiers (4) on overlay (3). A light-emitting diode (17) or other suitable indicator can be used to indicate if a flavor is unavailable, actuation of the flavor button, or other suitable information.

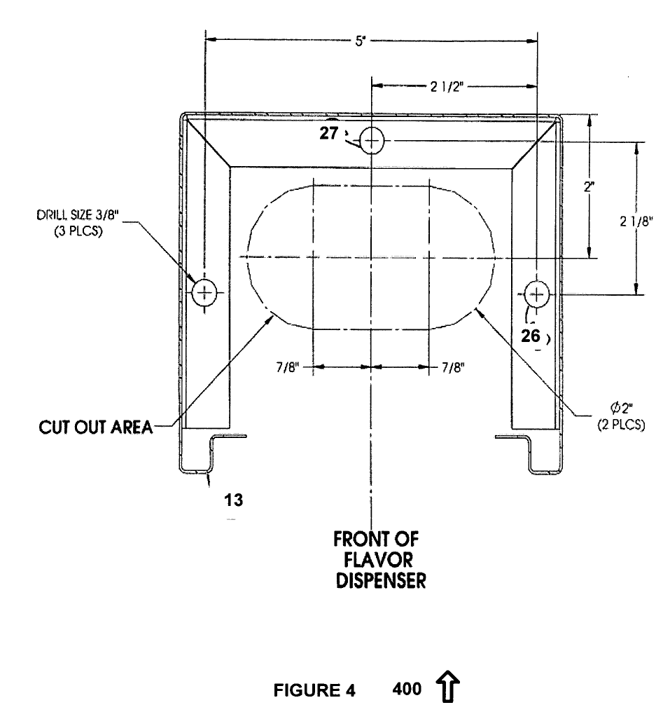

FIG. 4 is a diagram 400 of a template for a flavor dispenser in an exemplary embodiment of the present invention. The dimensions of this template can be altered where suitable to encompass additional embodiments of the invention. The exemplary embodiment shown in the figure illustrates where holes should be drilled (27) in order to fasten the main tower (13) to a countertop or other surface.

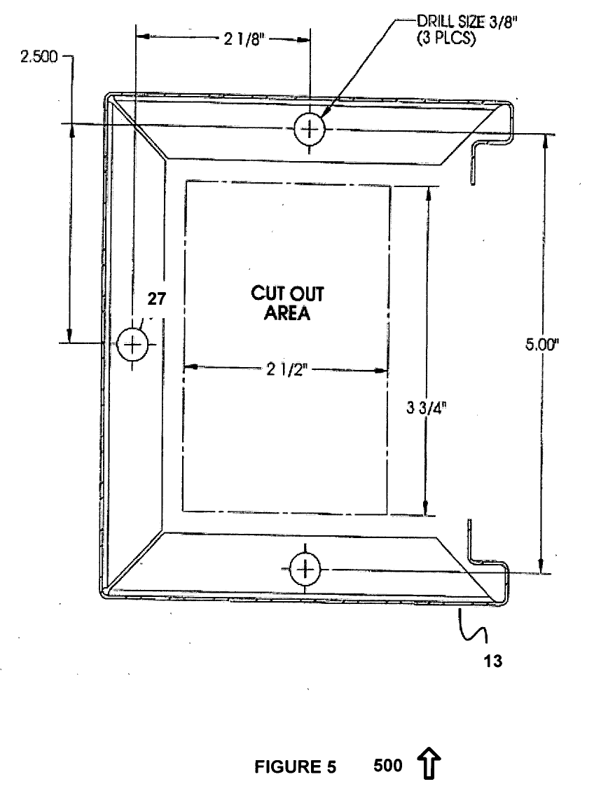

FIG. 5 is a diagram 500 of a template for a flavor dispenser in an exemplary embodiment of the current invention. The dimensions of this template can be altered where suitable to encompass additional embodiments of the invention. The exemplary embodiment shown in the figure illustrates where holes should be drilled (27) in order to fasten the main tower (13) to a countertop or other surface.

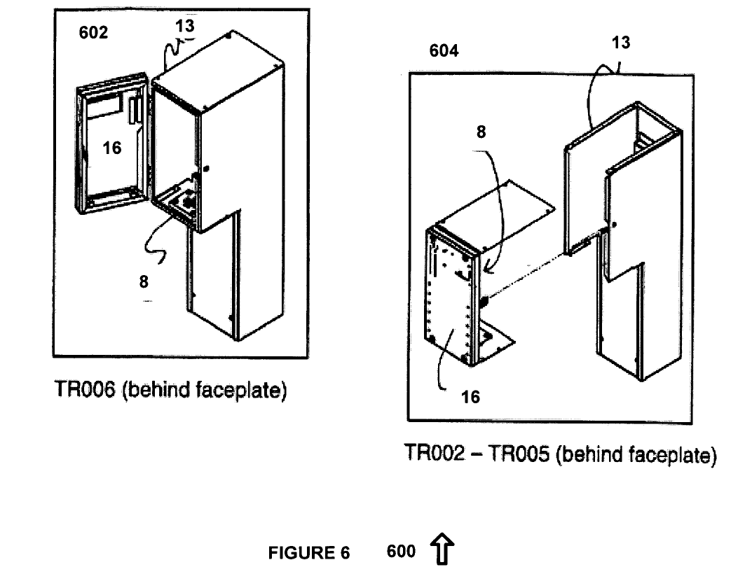

FIG. 6 shows two exemplary locations for the control board (8) in exemplary embodiments of the invention. In 606, the control board (8) is attached behind the faceplate (16) which is attached to main tower (13) with a hinged frame to allow easy access for repair. In 604, the control board (8) is attached behind the faceplate (16) and the faceplate (16) is bolted to the main tower (13), which limits access and potential tampering but which also makes it more difficult to repair

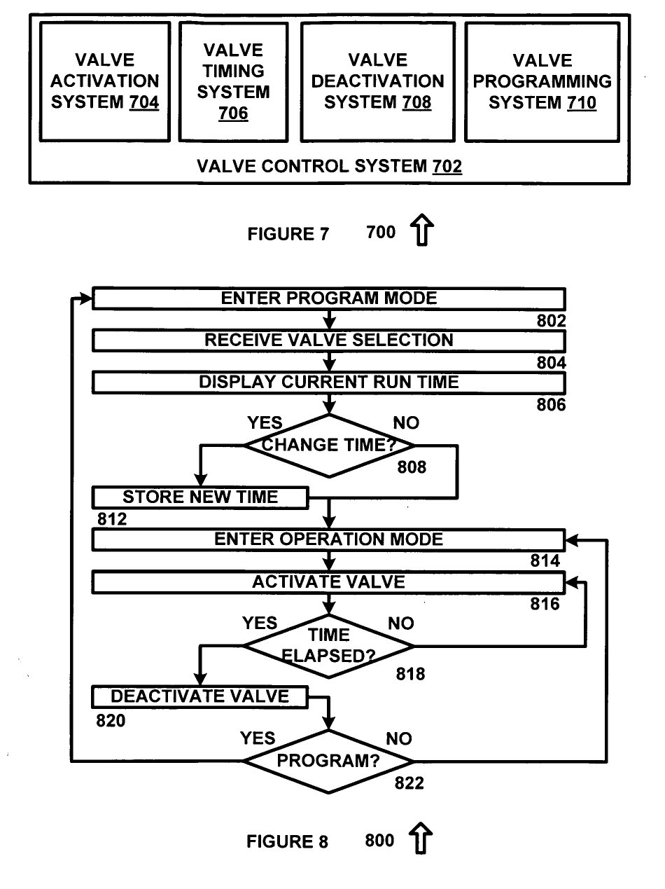

FIG. 7 is a diagram of a system 700 for controlling a flavor dispenser in accordance with an exemplary embodiment of the present invention. System 700 includes valve control system 702, valve activation system 704, valve timing system 706, valve deactivation system 708 and valve programming system 710, each of which can be implemented in hardware, software, or a suitable combination of hardware and software, and which can be one or more software systems operating on a processing platform. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Valve control system 702 receives user control inputs and valve programming inputs and controls the configuration and operation of a plurality of valves for controlling dispensing of flavoring compounds. In one exemplary embodiment, valve control system 702 can control a plurality of solenoid valves that regulate the flow of flavoring compounds, such as in a system where a plurality of pneumatic pumps provide flavoring syrups at a regulated pressure. Likewise, valve control system 702 can control other suitable systems, such as systems where pumps are operated to control delivery of flavoring compounds, systems utilizing other suitable valves, or other suitable systems.

Valve activation system 704 receives one or more user control selections and activates one or more associated valves, such as solenoid valves. In one exemplary embodiment, user-selectable buttons can be used to generate user control selection signals.

Valve timing system 706 provides valve timing information in response to valve activation data. In one exemplary embodiment, when a user control selection is received, timing data for an associated valve can be received from valve timing system 706, such that each valve can be assigned a different run time, the same run time, or other suitable run times.

Valve deactivation system 708 received timing data and deactivates a selected valve or valves upon expiration of the timing data. In one exemplary embodiment, valve deactivation system 708 can deactivate different valves at different times, such as where the timing data associated with each of plurality of valves is different for one or more of the plurality of valves.

Valve programming system 710 receives valve programming data so as to allow a user to program one or more run times for each of a plurality of valves. In one exemplary embodiment, valve programming data can be used to ignore user control selections that are less than a predetermined time, such as where a user may have inadvertently depressed a control, to activate a valve for a programmed period of time when a user control selection is within a predetermined period of time, to allow a user to cause a valve to flow as long as desired when a user control selection continues for a predetermined period of time, or in other suitable manners. Likewise, the programmed length of operation for each of a plurality of valves can be set to different times where suitable, or other suitable programming functions can be provided.

In operation, system 700 allows a user to operate or program a flavoring compound dispenser so as to allow users to dispense flavoring compounds such as syrups into beverages in predetermined quantities, and also to allow operators to control the operation of a flavor dispensing system.

FIG. 8 is a flow chart of a method 800 for programming and controlling a flavoring compound dispenser in accordance with an exemplary embodiment of the present invention. Method 800 begins at 802, where a programming mode is entered, such as by receiving a user code or other suitable control. The method then proceeds to 804, where a valve selection is received. The programmable valve selection can include a selection from one of a plurality of valves. The method then proceeds to 806.

At 806, a current run time is displayed, and the method proceeds to 808, where it is determined whether a control has been received to change the valve run time. In one exemplary embodiment, a user can use controls to increase or decrease the valve run time, can select different run time settings in response to different user-selectable control inputs, or other suitable control settings can be received. If a control setting is not received, the method proceeds to 814. Otherwise, the method proceeds to 812 where the new valve run time is stored. The method then proceeds to 814.

At 814, the method enters operation mode. Likewise, a prompt can be provided to allow the user to return to 804 and program more valve run times. The method then proceeds to 816 where a valve is activated, such as in response to a user-entered valve selection, selection of a dispenser button, or in other suitable manners. The method then proceeds to 818, where it is determined whether a programmed valve run time has elapsed. If the valve run time has not elapsed, the method returns to 816, otherwise, the method proceeds to 820 where the valve is deactivated. The method then proceeds to 822.

At 822, it is determined whether a control has been received enter the programming mode. If a control has been received, the method returns to 802. Otherwise, the method returns to 814 and resumes normal operation.

In operation, method 800 provides an exemplary control process for a system for dispensing flavoring compounds, and can be implemented as a software system for a programmable controller or in other suitable manners.

In operation, the invention can include an apparatus for dispensing flavors, such as to beverages. The apparatus includes a housing, a pump assembly, a valve assembly, a nozzle assembly for dispensing flavor compounds, and a control board including a user interface which is capable of activating the valves in the valve assembly.

The flavor compounds to be dispensed can include any suitable flavoring compound that is packaged in a consumable format, such as syrups, liquids, powders, or other suitable compounds, each having a different flavor, including but not limited to peach, mango, raspberry, orange, black currant, lime, cranberry, vanilla, mint, lemon, sarsaparilla, cherry, peppermint, hazelnut, melon, caramel, almond, amaretto, gingerbread, pumpkin, eggnog, blackberry, chocolate, Irish cream, cinnamon, licorice and combinations thereof.

In one exemplary embodiment, the housing includes a main tower, which can be constructed of wood, plastic, metal, or other suitable solid or composite materials. The housing can be mounted on a countertop or other work surfaces in a home, office, food preparation area, or other suitable locations. The housing can include removable graphics labels for identifying the flavor options to a customer, and can also include a drip tray for preventing accidental spills of flavoring. In this embodiment, the housing can be 7.25″ wide with a drip tray (or 6.0″ without a drip tray), 11.13″ deep, and 23.0″ high. The housing can also comprise a 24 volt D.C. power cord, or an aperture capable of being fitted with such a cord. The housing can also be fitted with a power supply, or can be capable of being fitted with a power supply.

In one exemplary embodiment, the pump assembly can include one or more pneumatic pumps, each connected to a source of pneumatic power such as a pressurized CO₂ tank, a source of flavor compound, and the input of a valve, such as a solenoid valve or other suitable valves. A nozzle for dispensing the flavor compound is connected to the output of the valve. Each valve can be connected to a suitable power source, such as a 24 volt D.C. solenoid power supply. Each valve can be activated by a control board, which is connected to a user interface, which can be accomplished when the user presses one or more buttons in contact with the control board. In this embodiment, each valve can be activated for a specified period of time, such as a continuously or discretely varied period or time between 0.25 and 2.00 seconds, a period of time that has been pre-programmed by an operator, or other suitable periods of time. Flavor compound may be dispensed using the interface in increments that are based on the length of time that the valve operates, such as 1/10 of an ounce for 0.25 seconds, and the user may select one of 12 flavors. The operation time for the valve for one flavor compound can be different from the operation time for the valve for a different flavor compound, such as where different flavors are provided in different strengths.

In addition, the buttons in contact with the control board can be programmed to activate the valves to pour and hold with a specified time-out or programmed with a guard time delay to prevent accidental dispensing of flavor, such as when a button is accidentally pressed for a short period of time.

When a plurality of valves are included in the valve assembly, the control board can be capable of activating one or more of the plurality of valves. In this exemplary embodiment, the pumps may be 15 p.s.i. pneumatic pumps capable of dispensing flavor in liquid form, such that the pressure in the supply line is maintained when the valves are actuated by the pneumatic pumps. Other suitable pumps can also or alternatively be used. The flavor compound may be packaged in a bag-in-box container with a ¼″ fitting capable of being connected to ¼″ tubing in the pump assembly. Table 1 shows an exemplary amount of flavoring compound (“shot”) that can be dispensed with different periods of valve activation.

TABLE 1
Shot Size with 15 p.s.i. Pump

| seconds | ml/shot | oz/shot |
|---|---|---|
| 0.250 | 2.3 | 0.08 |
| 0.500 | 4.8 | 0.16 |
| 0.750 | 7.0 | 0.23 |
| 1.000 | 9.2 | 0.31 |

In this exemplary embodiment, the apparatus can be fitted with electrical and tubing connections, which can exit from the bottom of the main tower or from other suitable locations. An electrical transformer can be included, such as a 24 volt A.C., 1.0 amp transformer with wire harness and power cord. Internal wiring connecting the power source or control board with the valves can be color-coded to facilitate assembly and maintenance. In addition, the main tower can accept a 2-pin connector from a transformer, such as at the bottom of the main tower.

The control board is electrically coupled to multiple buttons representing specific flavors to be dispensed. The control board can also include a liquid crystal display to allow the user to see the status and programmed parameters of each valve. The liquid crystal display can be programmed to shut off automatically after a period of inactivity, such as one minute, to reduce power consumption. Additional controls can also or alternatively be provided to allow the user to scroll between valves to be programmed. Flavor buttons can be programmed individually to provide timed dispenses, such as between 0.25 and 2.00 seconds in increments of 0.25 seconds, can be provided with a default run time such as 0.5 seconds, can be configured to provide a pour and hold function with a timeout such as 25 seconds, can be configured with a guard time delay (such as from 0.0 to 1.0 seconds in increments of about 0.05 seconds with a default value of 0.10 seconds) in order to avoid accidental activation of the controls, or can be configured in other suitable manners. In this exemplary embodiment, programmed times can be stored in non-volatile memory to allow them to be retained when the unit is not powered.

In one exemplary embodiment, the pump assembly can include a source of pressured liquid or gas, such as carbon dioxide gas (CO₂). The source of pressurized liquid or gas can be provided in fluid communication with one or more pumps, and can supply pressure to assist in the movement of the flavoring compound through the pump and valve and through the nozzle.

Although exemplary embodiments of an apparatus of the present invention have been described in detail herein, those skilled in the art will also recognize that various substitutions and modifications can be made to the apparatus without departing from the scope and spirit of the appended claims.

What is claimed is:

1. An apparatus for dispensing flavoring compounds, comprising:
a housing;
a plurality of flavor compound containers;
a plurality of pump assemblies, each in fluid communication with one of the flavor compound containers and each having a nozzle for dispensing a flavor compound directly into a vessel; and
a control board comprising a plurality of user controls, wherein selection of one of the user controls activates one of the plurality of pump assemblies for a predetermined period of time.

2. The apparatus of claim 1, further comprising a plurality of solenoid valves, each coupled between one of the pump assemblies and the nozzle of the pump assembly, wherein the solenoid valve is used to control a predetermined quantity of the flavor compound.

3. The apparatus of claim 1, wherein the predetermined period of time can be programmed by an operator.

4. The apparatus of claim 3, wherein the predetermined period of time is adjustable between about 0.25 and 2.00 seconds in 0.25 second increments.

5. The apparatus of claim 1, wherein the pump assembly further comprises a source of pressurized liquid or gas which is in fluid communication with the pump.

6. The apparatus of claim 5, wherein the source of pressurized liquid or gas is a container of carbon dioxide gas.

7. The apparatus of claim 1, wherein the control board further comprises a liquid crystal display.

8. The apparatus of claim 1, wherein the housing is fitted with a connector for a 24V power cord to supply power for the control board.

9. The apparatus of claim 1, further comprising a splash panel.

10. The apparatus of claim 1, further comprising a drip plate.

11. The apparatus of claim 1, wherein the source of flavoring compound is in communication with the pump via tubing.

12. The apparatus of claim 11, wherein the tubing is ¼″ tubing.

13. The apparatus of claim 1, wherein the source of flavoring compound is syrup.

14. The apparatus of claim 13, wherein the syrup is packaged in bag-in-box (BIB) containers.

15. The apparatus of claim 13, wherein a flavor of the syrup is selected from the group consisting of peach, mango, raspberry, orange, black currant, lime, cranberry, vanilla, mint, lemon, sarsaparilla, cherry, peppermint, hazelnut, melon, caramel, almond, amaretto, gingerbread, pumpkin, eggnog, blackberry, chocolate, Irish cream, cinnamon, licorice and combinations thereof.

16. A method for dispensing flavoring compounds, comprising:
applying a source of power to a plurality of pump assemblies;
receiving a user selection of a control;
activating one or more of a plurality of valves in response to the user selection of the control, wherein each valve is coupled to one of the pump assemblies;
dispensing a flavoring compound directly into a vessel; and
deactivating the one or more of the plurality of valves after a programmed time interval.

17. The method of claim 16 further comprising:
receiving a command to enter a programming mode;
receiving a valve selection;
programming the time interval for the selected valve.

18. The method of claim 16 wherein applying the source of power to the plurality of pump assemblies comprises applying a pneumatic power source to one or more of pump assemblies.

19. An apparatus for dispensing flavoring compounds, comprising:
means for dispensing a flavor compound into a vessel; and
means for controlling a length of time of operation of a valve in response to selection of a user control.

20. The apparatus of claim 19 further comprising means for programming valve operation times.
